(19) United States
(12) Patent Application Publication
(10) Pub. No.: US 2025/0239044 A1
(43) Pub. Date: Jul. 24, 2025

(54) APPARATUS, METHOD AND READABLE STORAGE MEDIUM FOR IMAGE PROCESSING MODEL TRAINING

(71) Applicant: Huawei Technologies Co., Ltd., Shenzhen (CN)

(72) Inventors: Huan Liu, North York (CA); Zhixiang Chi, Vaughan (CA); Li Gu, Markham (CA); Yuanhao Yu, Markham (CA); Yang Wang, Montreal (CA); Jin Tang, Markham (CA)

(21) Appl. No.: 18/418,052

(22) Filed: Jan. 19, 2024

(51) Int. Cl. G06V 10/44; G06T 7/12; G06V 10/56

(52) U.S. Cl. CPC G06V 10/44; G06T 7/12; G06V 10/56; G06T 2207/20084

(57) ABSTRACT

This disclosure relates to the field of image processing, and discloses an apparatus, method and readable storage medium for image processing model training. The model includes multiple prompt modules and multiple image processing modules corresponding to multiple prompt modules. The method comprising: input N sample images into multiple prompt modules to add corresponding prompt information to the N sample images. Thus, N prompt sample images corresponding to each image processing module may be obtained. And then input the N prompt sample images into each image processing module, to obtain N prediction results corresponding to the each image processing module. Then parameters of multiple image processing modules and multiple prompt modules can be adjusted based on N prediction results and N reference results corresponding to each image processing module.

### TECHNICAL FIELD

The present disclosure relates to the field of image processing, and in particular, to an apparatus, method and readable storage medium for image processing model training.

### BACKGROUND

In the field of image processing, one target task, such as target detection, image recognition, semantic segmentation, and depth estimation, is typically completed using one neural network model (such as a convolutional neural network, (CNN)). As shown in FIG. 1, take that the electronic device is a mobile phone as an example, target detection may be performed on the cat in image A1 based on CNN-1, to obtain image A2. Image recognition may be performed on the dog in image B1 based on CNN-2, to obtain a “dog” recognition result. Performing semantic segmentation on the vehicle and the trees in image C1 based on CNN-3, to obtain image C2. Depth estimation is performed on the sofa and the table in image D1 based on CNN-4, to obtain image D2. However, in the foregoing method, one model can be used to perform only one target task, causing low processing efficiency. Thus, there is a need to improve upon the approach of using one model to perform only one target task.

### SUMMARY

The following examples pertain to embodiments described throughout this disclosure.

One or more embodiments may include an image processing model training apparatus, the image processing model which is a convolutional neural network model including Y prompt modules and M image processing modules, each of the M image processing modules corresponding to at least one of the Y prompt modules, the apparatus comprising: a memory for storing instructions; and one or more processors for executing the instructions to cause the apparatus to: acquire sample data including N sample images and a reference result corresponding to each of the N sample images; add corresponding prompt information to the N sample images based on the Y prompt modules, to obtain N prompt sample images corresponding to each image processing module, wherein the prompt information is related to each image processing task of each image processing module; predict the N prompt sample images corresponding to each image processing module, to obtain N prediction results corresponding to the each image processing module; and adjust parameters of the M image processing modules and the Y prompt modules based on the N prediction results and N reference results corresponding to each image processing module.

In the training process of the image processing model, prompt information can be added to the sample images to obtain prompt sample images. And then the prompt sample images can be used to execute the corresponding image processing task. What's more, the prompt information added is related to each image processing task, so the prompt sample images may be useful to the execution of the image processing task. By doing so, accuracy of prediction result of each image processing task may be improved.

One or more embodiments may include an image processing model training apparatus, wherein add corresponding prompt information to the N sample images based on the Y prompt modules comprises: changing pixel values of at least a portion of pixels in the N sample images; or, adding image areas around the N sample images to expand the N sample images.

One or more embodiments may include an image processing model training apparatus, wherein an image processing task corresponding to an image processing module is image recognition; and a manner in which prompt information corresponding to the image processing task is added to the N sample images comprises: changing pixel values of outline of each object to be recognized in the N sample images.

One or more embodiments may include an image processing model training apparatus, wherein an image processing task corresponding to an image processing module is semantic segmentation; and a manner in which prompt information corresponding to the image processing task is added to the N sample images comprises: changing pixel values of at least a portion of pixels of each object to be segmented in the N sample images.

One or more embodiments may include an image processing model training apparatus, wherein an image processing task corresponding to an image processing module is depth estimation; and a manner in which prompt information corresponding to the image processing task is added to the N sample images comprises: changing pixel values of pixels of each object to be estimated in the N sample images to increase color comparisons between objects to be estimated.

One or more embodiments may include an image processing model training apparatus, wherein the image processing model further comprises a feature extraction module which is configured to: perform feature extraction on the N prompt sample images output by each prompt module, and input extracted feature into the M image processing modules corresponding to the Y prompt modules.

One or more embodiments may include an image processing model training method. The image processing model which is a convolutional neural network model including Y prompt modules and M image processing modules, each of the M image processing modules corresponding to at least one of the Y prompt modules, the method comprising: acquire sample data including N sample images and a reference result corresponding to each of the N sample images; add corresponding prompt information to the N sample images based on the Y prompt modules, to obtain N prompt sample images corresponding to each image processing module, wherein the prompt information is related to each image processing task of each image processing module; predict the N prompt sample images corresponding to each image processing module, to obtain N prediction results corresponding to the each image processing module; and adjust parameters of the M image processing modules and the Y prompt modules based on the N prediction results and N reference results corresponding to each image processing module.

In the training process of the image processing model, prompt information can be added to the sample images to obtain prompt sample images. And then the prompt sample images can be used to execute the corresponding image processing task. What's more, the prompt information added is related to each image processing task, so the prompt sample images may be useful to the execution of the image processing task. By doing so, accuracy of prediction result of each image processing task may be improved.

One or more embodiments may include an image processing model training method, wherein add corresponding prompt information to the N sample images based on the Y prompt modules comprises: changing pixel values of at least a portion of pixels in the N sample images; or, adding image areas around the N sample images to expand the N sample images.

One or more embodiments may include an image processing model training method, wherein an image processing task corresponding to an image processing module is image recognition; and a manner in which prompt information corresponding to the image processing task is added to the N sample images comprises: changing pixel values of outline of each object to be recognized in the N sample images.

One or more embodiments may include an image processing model training method, wherein an image processing task corresponding to an image processing module is semantic segmentation; and a manner in which prompt information corresponding to the image processing task is added to the N sample images comprises: changing pixel values of at least a portion of pixels of each object to be segmented in the N sample images.

One or more embodiments may include an image processing model training method, wherein an image processing task corresponding to an image processing module is depth estimation; and a manner in which prompt information corresponding to the image processing task is added to the N sample images comprises: changing pixel values of pixels of each object to be estimated in the N sample images to increase color comparisons between objects to be estimated.

One or more embodiments may include an image processing model training method, wherein the image processing model further comprises a feature extraction module which is configured to: perform feature extraction on the N prompt sample images output by each prompt module, and input extracted feature into the M image processing modules corresponding to the Y prompt modules.

One or more embodiments may include a machine-readable storage medium storing instructions, which when executed by one or more processors, cause the machine to: acquire sample data including N sample images corresponding to M image processing modules and a reference result corresponding to each of the N sample images, and the M image processing modules and Y prompt modules constitute an image processing model which is a convolutional neural network model, wherein each of the M image processing modules corresponds to at least one of the Y prompt modules; add corresponding prompt information to the N sample images based on the Y prompt modules, to obtain N prompt sample images corresponding to each image processing module, wherein the prompt information is related to each image processing task of each image processing module; predict the N prompt sample images corresponding to the each image processing module, to obtain N prediction results corresponding to each image processing module; and adjust parameters of the M image processing modules and the Y prompt modules based on the N prediction results and N reference results corresponding to each image processing module.

In the training process of the image processing model, prompt information can be added to the sample images to obtain prompt sample images. And then the prompt sample images can be used to execute the corresponding image processing task. What's more, the prompt information added is related to each image processing task, so the prompt sample images may be useful to the execution of the image processing task. By doing so, accuracy of prediction result of each image processing task may be improved.

One or more embodiments may include a machine-readable storage medium storing instructions, wherein add corresponding prompt information to the N sample images based on the Y prompt modules comprises: changing pixel values of at least a portion of pixels in the N sample images; or, adding image areas around the N sample images to expand the N sample images.

One or more embodiments may include a machine-readable storage medium storing instructions, wherein an image processing task corresponding to an image processing module is image recognition; and a manner in which prompt information corresponding to the image processing task is added to the N sample images comprises: changing pixel values of outline of each object to be recognized in the sample images.

One or more embodiments may include a machine-readable storage medium storing instructions, wherein an image processing task corresponding to an image processing module is semantic segmentation; and a manner in which prompt information corresponding to the image processing task is added to the N sample images comprises: changing pixel values of at least a portion of pixels of each object to be segmented in the N sample images.

One or more embodiments may include a machine-readable storage medium storing instructions, wherein an image processing task corresponding to an image processing module is depth estimation; and a manner in which prompt information corresponding to the image processing task is added to the N sample images comprises: changing pixel values of pixels of each object to be estimated in the N sample images to increase color comparisons between objects to be estimated.

One or more embodiments may include a machine-readable storage medium storing instructions, wherein the image processing model further comprises a feature extraction module which is configured to: perform feature extraction on the N prompt sample images output by each prompt modules, and input extracted feature into the M image processing modules corresponding to the Y prompt modules.

One or more embodiments may include an image processing model. The image processing model includes Y prompt modules and M image processing modules, each of the M image processing modules corresponding to at least one of the Y prompt modules; and, the Y prompt modules are configured to add prompt information to an image to be processed to obtain prompt images, wherein the prompt information is related to M image processing tasks of the M image processing modules corresponding to the Y prompt modules; the M image processing modules are configured to generate, based on the prompt images generated by corresponding prompt modules, image processing result corresponding to the image to be processed.

The image processing model mentioned above includes Y prompt modules and M image processing modules corresponding to Y prompt modules. The number of prompt modules and image processing modules may be the same or different. The prompting modules are configured to add prompt information to the image to be processed, and then image processing modules corresponding to the prompting modules execute corresponding image processing tasks on the image to be processed after the prompt information is added. The added prompt information, which is related to corresponding image processing tasks, may be used to change pixel values of at least a part of pixels in the image to be processed or add image areas around the image to be processed. Therefore, this model structure may help to execute corresponding image processing tasks, and improve accuracy of prediction results of the image processing tasks.

One or more embodiments may include an image processing model, wherein manners in which the Y prompt modules add prompt information to the image to be processed comprises: changing, by the Y prompt modules, pixel values of at least a portion of pixels in the image to be processed; or, adding, by the Y prompt modules, image areas around the image to be processed, so as to expand the image to be processed.

One or more embodiments may include an image processing model, wherein an image processing task corresponding to an image processing module is image recognition; and a manner in which a corresponding prompting module adds prompt information to the image to be processed comprises: changing pixel values of outline of each object to be recognized in the image to be processed.

One or more embodiments may include an image processing model, wherein an image processing task corresponding to an image processing module is semantic segmentation; and a manner in which a corresponding prompting module adds prompt information to the image to be processed comprises: changing pixel values of at least a portion of pixels of each object to be segmented in the image to be processed.

One or more embodiments may include an image processing model, wherein an image processing task corresponding to an image processing module is depth estimation; and a manner in which a corresponding prompting module adds prompt information to the image to be processed comprises: changing pixel values of pixels of each object to be estimated in the image to be processed, increasing color comparisons between objects to be estimated.

One or more embodiments may include an image processing model, wherein the image processing model further comprises a feature extraction module which is configured to: perform feature extraction on the prompt images output by the Y prompt modules, and input extracted feature into the M image processing modules corresponding to the Y prompt modules.

One or more embodiments may include an image processing model, wherein M is equal to Y, and the M image processing modules are in a one-to-one correspondence with the Y prompt modules.

One or more embodiments may include an image processing model, wherein the image processing model is a convolutional neural network model.

### BRIEF DESCRIPTION OF THE DRAWINGS

To illustrate more clearly the technical features in embodiments of this disclosure, a brief description of the drawings in the description of embodiments is provided below. Obviously, the drawings in the following description are only some examples of this disclosure. For the general technical personnel in this art, other drawings can be obtained based on these drawings without creative labor.

FIG. 1 shows a schematic flow diagram of target tasks' execution by using multiple neural network models, according to some embodiments of the present disclosure;

FIG. 2 shows a schematic flow diagram of target tasks' execution by using a multi-task learning model, according to some embodiments of the present disclosure;

FIG. 3A shows the first model structure diagram of an image processing model, according to some embodiments of the present disclosure;

FIG. 3B shows the second model structure diagram of an image processing model, according to some embodiments of the present disclosure;

FIG. 3C shows the third model structure diagram of an image processing model, according to some embodiments of the present disclosure;

FIG. 3D shows the fourth model structure diagram of an image processing model, according to some embodiments of the present disclosure;

FIG. 3E shows a schematic flow diagram of an image processing method, according to some embodiments of the present disclosure;

FIG. 4A shows a schematic diagram of adding target pixel values to each pixel of an image to be processed, according to some embodiments of the present disclosure;

FIG. 4B shows a schematic diagram of adding target pixel values around an image to be processed, according to some embodiments of the present disclosure;

FIG. 5 shows a schematic flow diagram of executing image processing on an image to be processed including a sofa and a table, according to some embodiments of the present disclosure;

FIG. 6 shows a schematic flow diagram of training first prompt sub-models, according to some embodiments of the present disclosure;

FIG. 7 shows a schematic flow diagram of training first prompt sub-models and the first sub-model, according to some embodiments of the present disclosure;

FIG. 8 shows a schematic flow diagram of training the image processing model when a second target task is added, according to some embodiments of the present disclosure;

FIG. 9 shows a schematic diagram of a first electronic device and a second electronic device, according to some embodiments of the present disclosure;

FIG. 10 shows a schematic structural diagram of an apparatus, according to some embodiments of the present disclosure.

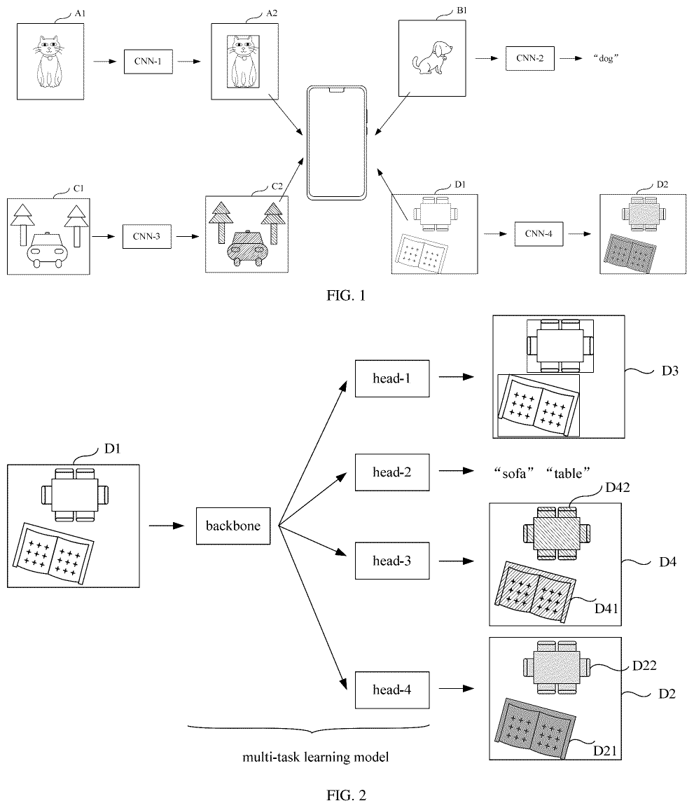

### DETAILED DESCRIPTION OF ILLUSTRATIVE EMBODIMENTS

Illustrative embodiments of the present disclosure include, but are not limited to, an apparatus, method and readable storage medium for image processing model training.

In general, a multi-task learning method may be used to deal with multiple target tasks at the same time. Multi-task learning may execute multiple target tasks by using one model (hereinafter referred to as a multi-task learning model). A multi-task learning model may include one backbone and multiple heads, and one head is used to perform one target task, such as a target detection task. A backbone may be configured to perform feature extraction on an input image, and each head performs, based on the image feature extracted by the backbone, corresponding target task, so as to output the prediction result of the target task.

Thus, parameters of a backbone and each head in the multi-task learning model may need to be trained to obtain a multi-task learning model that can perform each target task. Moreover, when the capability of executing a new target task should be added in the multi-task learning model, after the new head corresponding to the new target task is added, parameters of the backbone and each head (including parameters of the new head) should be re-trained. Therefore, the quantity of parameters to be trained is relatively large, resulting in a relatively complex training process.

As described above, a multi-task learning model includes one backbone and multiple heads, and one head corresponds to one target task. Therefore, a multi-task learning model may execute multiple target tasks. In FIG. 2, when the target task corresponding to the head-1 is a target detection task for detecting the sofa and the table in image D1, after image D1 is input to the multi-task learning model, the head-1 in the model may perform target detection on image D1, and output the prediction result shown in D3. In D3, the sofa and the table are separately identified using boundary boxes.

When the target task corresponding to the head-2 is an image recognition task for identifying the target element (the sofa and the table) in image D1, after image D1 is input to the multi-task learning model, the head-2 in the model may perform image recognition on image D1, and output prediction results of the “sofa” and the “table”.

When the target task corresponding to the head-3 is a task for performing semantic segmentation on each target element in image D1, after image D1 is input to the multi-task learning model, the head-3 in the model may perform semantic segmentation on image D1, and output the semantic image shown in image D4. Different regions in image D4 represent different types of target elements. For example, area D41 in image D4 represents the sofa, and area D42 represents the table.

When the target task corresponding to the head-4 is a task for performing depth estimation on each target element in image D1, after image D1 is input to the multi-task learning model, the head-4 in the model may perform depth estimation on image D1, and output the depth image D2. In image D2, D21 represents the sofa, and D22 represents the table. It may be understood that in a depth image, the darker the color is, the greater depth of the target element is, which indicates a closer distance between the target element and the photographing point. Therefore, it may be learned that in image D2, D21 is closer to the photographing point than D22.

FIG. 2 is only described by using an example in which a multi-task learning model is used to execute multiple target tasks on image D1. However, it should be understood that the multi-task learning model may be further used to execute a corresponding target task on the foregoing image A1, image B1, image C1, or another different image. For example, each target task may be separately executed on an image that includes an animal, a character, a landscape, and the like by using a multi-task learning model. Details are not described herein again.

In the training process of the foregoing multi-task learning model, parameters of the backbone and each head generally need to be trained and updated.

For example, in some embodiments, the training method of a multi-task learning model may include:
Obtain a training set. If the training set includes N sample images and each sample image corresponds to M target tasks, then there will be N×M reference results. That is to say, the training set includes N sample images and N×M reference results, so the training set may be represented as D={xᵢ, yᵢ¹, . . . , yᵢ^{M}}ᵢ₌₁^{N}. represents the i th sample image and the value range of i is [1, N]. yᵢ^{j} represents a reference result of the j th target task corresponding to the i th sample image and the value range of j is [1, M]. For example, when i=1 and M=3, x₁ represents the first sample image and y₁¹1 represents the reference result of the first target task corresponding to the first sample image, y₁² represents the reference result of the second target task corresponding to the first sample image, and y₁³ represents the reference result of the third target task corresponding to the first sample image.

Input the training set into a multi-task learning model to train the model. In the process of training the multi-task learning model, in each training process, each sample image needs to be input into the model to obtain prediction results of multiple target tasks corresponding to each sample image. Then, a total result loss is obtained based on reference results and prediction results of the multiple target tasks corresponding to each sample image in the training set. Then, parameters of the backbone and each head are updated based on the total result loss, to obtain updated parameters. Based on the updated parameters and the training set, the multi-task learning model will be repeatedly trained in the foregoing way. Until the total result loss meets a training termination condition, a multi-task learning model after training may be obtained.

For example, the training termination condition may be any one of the followings: the quantity of update times of the model reaches a times threshold; the total result loss is less than a loss threshold; and the total result loss converges.

In addition, the multi-task learning model can be represented as

$${f}_{\{ {θ}_{b} , {θ}_{{t}_{1} , ... ,} {θ}_{{t}_{M}} \}} ,$$

wherein θ_{b} indicates parameters of the backbone, θₜ_{ⱼ} indicates parameters of head of the j th target task, and the value range of j is [1, M].

In the training process of the multi-task learning model, after the i th sample image xᵢ is input to the multi-task learning model, a prediction result from the model of the j th target task on the i th sample image

$${f}_{\{ {θ}_{b ,} {θ}_{{t}_{j}} \}} ( {x}_{i} ) \_i )$$

is obtained. Then a result loss

$${L}_{j} ( {f}_{\{ {θ}_{b ,} {θ}_{{t}_{j}} \}} ( {x}_{i} ) , {y}_{i}^{j} )$$

can be obtained based on the prediction result and the reference result of the j th target task. After that, each result loss for M target tasks and N sample images can be summed to obtain a total result loss, which is shown in the following formula (1):

$${L}_{total} = {\sum }_{i = 1}^{N} {\sum }_{j = 1}^{M} {L}_{j} ( {f}_{\{ {θ}_{b} , {θ}_{{t}_{j}} \}} ( {x}_{i} ) , {y}_{i}^{j} ) \qquad formula ( 1 )$$

After the total result loss is obtained, parameters of the backbone θ_{b} and parameters of each head θₜ_{₁}, . . . , θₜ_{_{M}} in the multi-task learning model are updated by using the total result loss, to obtain an updated multi-task learning model.

It may be learned from the foregoing content that, although the updated multi-task learning model may execute different target tasks on the input sample image, in the process of training, parameters of both the backbone and each head need to be trained and updated. Based on this, when the capability of executing a new target task (the new target task corresponds to a new head) should be added in the updated multi-task learning model, parameters of the backbone and each head including the new head need to be trained again, so that the model will achieve well prediction performance on multiple target tasks including the new target task. Therefore, in this case, the quantity of parameters to be trained is relatively large, resulting in a relatively complex training process.

Therefore, to resolve the foregoing technical problem, this disclosure provides an image processing method. In this method, during training of a multi-task learning model, prompt processing may be performed on the sample images in the training set by using prompt models. That is, the pixel value of at least part of pixels in the sample images is changed or a prompt mark is added to the sample images, to obtain the prompt sample images corresponding to each target task of the multi-task learning model. A prompt mark or a changed pixel value added to the sample images during the prompt processing process for a target task is strongly correlated with the task results of the target task.

Then, when the multi-task learning model is used to predict a sample image, each prompt sample image corresponding to each target task can be input into the multi-task learning model, to obtain the prediction results on the sample image.

Then, parameters of the prompt models and the multi-task learning model may be updated based on the prediction result of each target task corresponding to each sample image, until the prediction result of each target task corresponding to each sample image meets the training termination condition.

For example, assuming that a target task is to perform image recognition on a sample image including a “parrot”, prompt processing on the image may be, for example, changing the pixel values of the outline of the “parrot”. Assuming that a target task is to perform semantic segmentation on a sample image including a “parrot”, prompt processing on the image may be, for example, changing the pixel values of the outline of the “Parrot”, or the pixel values of all the pixels of the “parrot”, to distinguish the “parrot” from other objects in the sample image. For another example, if the target task is to perform depth estimation on a sample image including a “sofa” and a “table”, prompt processing on the image may be, for example, increasing the color contrast between the image part corresponding to the “sofa” and the image part corresponding to the “table” by changing the pixel value of pixels. In this way, the multi-task learning model can be helped perform depth estimation of image parts corresponding to “sofa” and “table”.

In other embodiments, all pixels in the sample image may be prompted for processing, such as changing the pixel values of all pixels in the sample image. Then the sample image after changing the pixel values is predicted, so the way of prompting on the sample image is not restricted in the present embodiment of the disclosure.

In the foregoing training process, parameters of the prompt model and head corresponding to each target task in the multi-task learning model may be updated based on the prediction result of each target task on each sample image. In this way, the prompt model and head that meets the condition for stopping training corresponding to each target task may facilitate execution of each target task.

In addition, when the capability of executing a new target task need to be added in the target multi-task learning model, only parameters of the new prompt model and the new head corresponding to the new target task may be trained. Compared with the method of training the whole model with parameters of the backbone and all heads including the new head, the method provided in this disclosure may reduce the quantity of parameters that need to be updated, causing relatively low calculation amount, thereby improving training efficiency.

Before describing in detail the image processing method provided in the embodiments of this disclosure, an electronic device is first described. It may be understood that the image processing method provided in this disclosure is applicable to any electronic device that can perform image processing, including but not limited to a mobile phone, a tablet computer, a wearable device, an augmented reality (AR) device and other devices. The type and form of the electronic device are not limited in this disclosure.

The model structure diagram of the image processing method will be described in following content first. It is understood that the image processing method provided in this disclosure can be realized based on an image processing model within the electronic device above. The image processing model may be a convolutional neural network model, which is not defined in this disclosure. In addition, in some embodiments, the image processing model may include Y prompt modules and M image processing modules, wherein both Y and M are positive integers, and Y may be greater than M, smaller than M, or equal to M. In addition, the prompt module is used to add the prompt information to the image to be processed, and the prompt information is related to the image processing task of the corresponding image processing module. The image processing module is used to perform the corresponding image processing task to generate the corresponding image processing result (the prediction result) based on the prompt image generated by the corresponding prompt module.

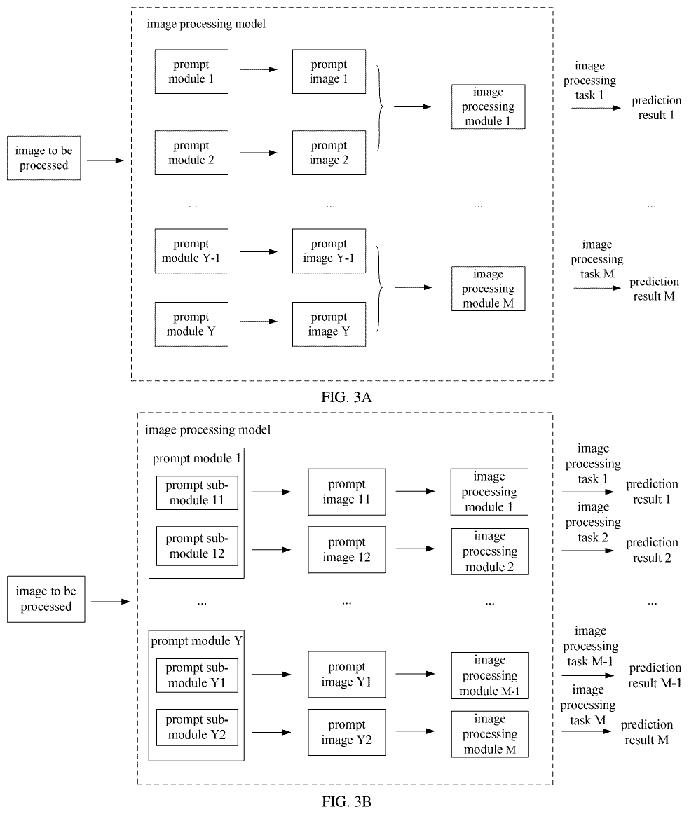

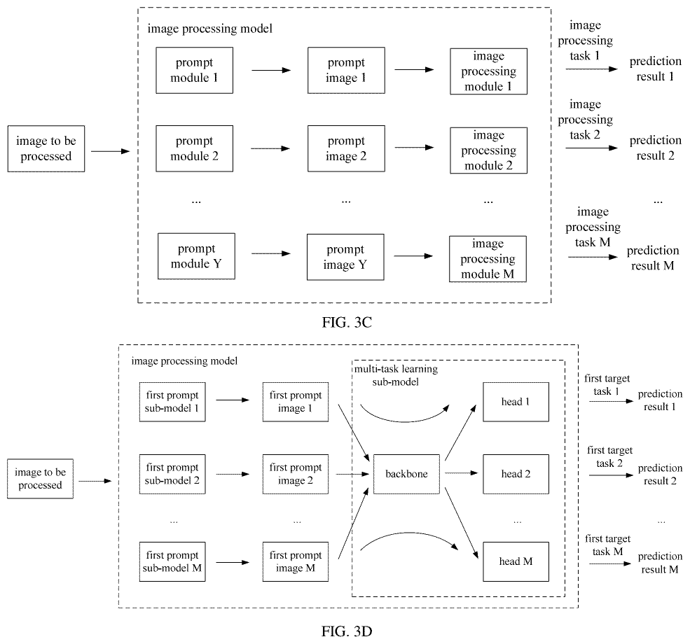

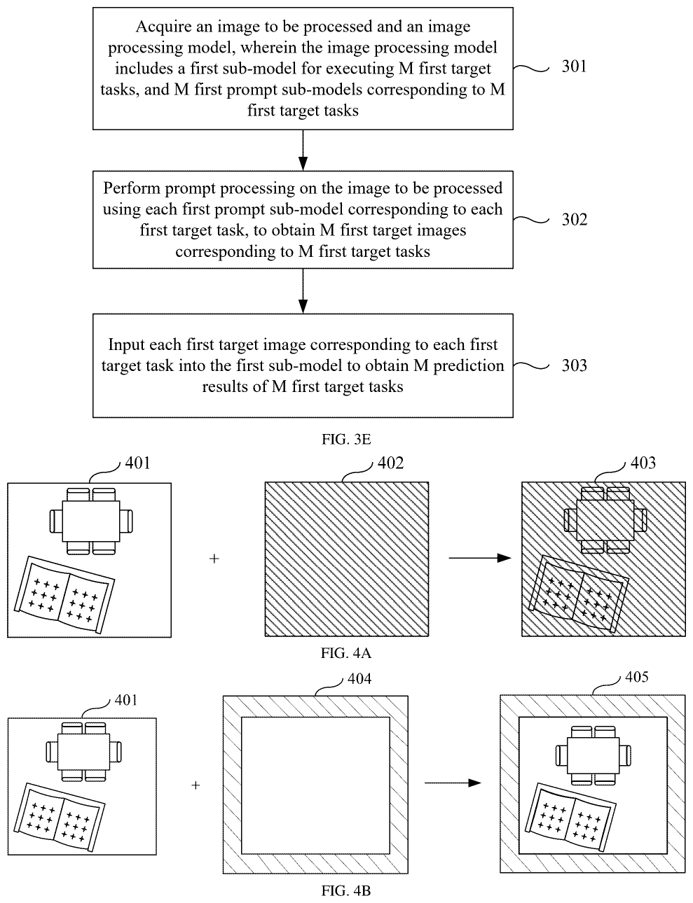

In some embodiments, when Y is greater than M, a plurality of prompt modules corresponds to an image processing module, and an image processing module is used to perform a corresponding image processing task. That is to say, multiple prompt modules can jointly help the execution of the corresponding image processing task by adding multiple prompt information to the image to be processed. The model structure diagram of the image processing model in this case is shown in FIG. 3A. As shown in FIG. 3A, take that one image processing module corresponds to two prompt models as an example, prompt module 1 and prompt module 2 correspond to image processing module 1, the prompt module Y-1 and the prompt module Y correspond to the image processing module M.

It can be understood that in the structure shown in FIG. 3A above, take the image processing task 1 executed on the basis of the input image to be processed as an example, after the image is input to the image processing model, the image can be prompted by the prompt module 1 and the prompt module 2 respectively, and then the prompt image 1 and the prompt image 2 can be obtained. After that, the prompt image 1 and the prompt image 2 can be input into the image processing module 1 to obtain the prediction result 1 corresponding to the image processing task 1.

In this case, the image processing module 1 can have the function of feature extraction for the prompt image 1 and the prompt image 2. In addition, the prompt modules can also have the feature extraction function, which means that after the prompt image 1 and the prompt image 2 are obtained, the prompt modules can then perform feature extraction for the image processing module 1 to perform the image processing task 1 based on the extracted features of the prompt image 1 and the prompt image 2. What's more, the image processing model may have a separate feature extraction module, which is used for extracting the features of the prompt image 1 and prompt image 2, and then the extracted features are input into the image processing module 1, to perform the corresponding image processing task 1.

In other embodiments, when Y is less than M, a prompt module corresponds to a plurality of image processing modules. In other words, at this time, a prompt module can have a number of sub-prompt modules, and a prompt sub-module corresponds to an image processing module. The model structure diagram of the image processing model in this case can be found in FIG. 3B. As shown in FIG. 3B, for example, a prompt module corresponds to two image processing modules, and a prompt module includes two prompt sub-modules. Prompt module 1 includes prompt sub-module 11 and prompt sub-module 12. The sub-module 11 corresponds to the image processing module 1, and the sub-module 12 corresponds to the image processing module 2. Similarly, prompt module Y includes prompt sub-module Y1 and prompt sub-module Y2, and prompt sub-module Y1 corresponds to image processing module M-1, prompt sub-module Y2 corresponds to image processing module M.

Taking the image processing task 1 to be processed on the basis of the input image as an example, after the image to be processed is input to the image processing model, the prompt sub-module 11 in the prompt module 1 can be used to perform prompt processing, to obtain the prompt image 11. Then, the prompt image 11 can be input into the image processing module 1 to obtain the prediction result 1 corresponding to the image processing task 1.

It can be understood that under the structure of the image processing model shown in FIG. 3B, the prompt modules can have the ability of image feature extraction, the image processing modules can have the ability of image feature extraction, or the feature extraction module in the image processing model has the ability of image feature extraction, which is not restricted in embodiments of the disclosure.

In other embodiments, when Y and M are equal, a prompt module corresponds to an image processing module. The model structure diagram of the image processing model in this case is shown in FIG. 3C. As shown in FIG. 3C, the prompt module 1 corresponds to the image processing module 1, and the prompt module Y corresponds to the image processing module M. Taking the image processing task 1 for example, after the image to be processed is input into the image processing model, the prompt module 1 can be first used to prompt the image to be processed, to obtain the prompt image 1. Then, the prompt image 1 can be input into the image processing module 1 to obtain the prediction result 1 corresponding to the image processing task 1.

It can be understood that under the structure of the image processing model shown in FIG. 3C, the prompt modules can have the ability of image feature extraction, the image processing modules can have the ability of image feature extraction, or the feature extraction module in the image processing model has the ability of image feature extraction, which is not restricted in embodiments of the disclosure.

Illustratively, if the image processing model has a feature extraction module, the feature extraction module and M image processing modules can form the multi-task learning sub-model mentioned above. The structure of the image processing model in this case is shown in FIG. 3D. Understandably, for ease of description, in FIG. 3D, the first prompt sub-model is equivalent to the prompt module mentioned above; the backbone in the multi-task learning sub-model is equivalent to the feature extraction module mentioned above; the first head is equivalent to the image processing module; and the first target task is equivalent to the image processing task. Understandably, since the number of the first prompt sub-models is the same as that of the first heads in the structure shown in FIG. 3D, which is Y=M, the number of first prompt sub-models is also described as M.

In FIG. 3D, after the image to be processed is input into the image processing model, prompt processing may be performed on the image to be processed based on the prompt sub-model 1 to obtain the first prompt image 1 corresponding to the image to be processed. Then, the first prompt image 1 may be input to the backbone in the multi-task learning sub-model, so as to perform feature extraction on the first prompt image 1. Then, the first head 1 executes the first target task 1 based on the feature extracted from the first prompt image 1 by the backbone, and then may output the prediction result 1 of the first target task 1.

After the image to be processed is input into the image processing model, prompt processing may be performed on the image to be processed based on the prompt sub-model M to obtain the first prompt image M corresponding to the image to be processed. Then, the first prompt image M may be input to the backbone in the multi-task learning sub-model, so as to perform feature extraction on the first prompt image M. Then, the first head M executes the first target task M based on the feature extracted from the first prompt image M by the backbone, and then may output the prediction result M of the first target task M.

Based on the foregoing model structure diagram shown in FIG. 3D, the following content will describe in detail an image processing method provided in this disclosure. FIG. 3E shows a schematic flow diagram of an image processing method. As shown in FIG. 3E, the method may include the following steps:

301: Acquire an image to be processed and an image processing model, wherein the image processing model includes a first sub-model for executing M first target tasks, and M first prompt sub-models corresponding to M first target tasks.

The embodiments of this disclosure sets no limitation on the type of image to be processed. For example, the image to be processed may be a landscape image, a figure image, an animal image, or the like. In some embodiments of this disclosure, the method in which the electronic device acquires the image to be processed may be that the electronic device receives the image to be processed uploaded by the user, or may be that the electronic device acquires the image to be processed from an image platform (for example, an image website).

In addition, in some embodiments of this disclosure, the first sub-model is a model corresponding to the multi-task learning. That is to say, the first sub-model can be the multi-task learning model shown in FIG. 3A, and the first sub-model has the capability of executing M first target tasks. What's more, this disclosure sets no limitation on the type of first target tasks. For example, first target tasks include but are not limited to target detection, image recognition, semantic segmentation, depth estimation, and the like.

It may be understood that a process in which the electronic device acquires the first sub-model may be considered as a process in which the electronic device acquires related parameters (for example, parameters of the backbone and each head) in the first sub-model. Therefore, the way in which the electronic device obtains the related parameters of the first sub-model is not limited in this disclosure. Take the electronic device which is a mobile phone as an example, the related parameters of the first sub-model may be trained on the cloud server, and then sent by the cloud server to the mobile phone. In this case, the way in which the electronic device obtains the related parameters of the first sub-model is: the mobile phone receives the related parameters sent by the cloud server.

302: Perform prompt processing on the image to be processed using each first prompt sub-model corresponding to each first target task, to obtain M first prompt images corresponding to M first target tasks.

It may be understood that an image may include multiple pixels. Pixel is the smallest image unit, and each pixel has a corresponding pixel value. For example, for a color image, pixel value of each pixel in the image is represented by R (red), G (green), and B (blue). For another example, for a binary image, a pixel value (also referred to as a grayscale value) of each pixel in the image is 0 or 255, wherein the grayscale value 0 represents black, and the grayscale value 255 represents white.

Therefore, in some embodiments of this disclosure, pixel values of at least a part of pixels in the image to be processed may be changed to perform prompt processing on the image to be processed. In addition, a prompt mark may also be added on the image to be processed, so as to perform prompt processing on the image to be processed. The form of the prompt mark and the way of adding the mark are not limited. For example, pixel values may be added around the image to be processed, so as to perform prompt processing on the image to be processed.

It should be understood that pixel values added to at least a part of pixel areas in the image to be processed or the prompt mark added to the image to be processed is also pre-trained, and is a kind of prompt information strongly related to each prediction result of each corresponding first target task. In some embodiments, prompt processing may be performed on the image to be processed by using a first prompt sub-model. It may be understood that in this case, the process of obtaining each trained prompt information is a process of obtaining each trained first prompt sub-model. A first prompt information corresponding to a first target task can be added to the image to be processed by a first prompt sub-model, so in some embodiments, M prompt processing may be performed on the image to be processed based on M prompt sub-models, to obtain M first prompt images. The training process of each first prompt sub-model will be described in detail later, so details are not described herein again.

In conclusion, it may be understood that one prompt processing performed on the image to be processed is used to execute a first target task, and one first prompt image obtained by one prompt processing on the image to be processed also corresponds to one first target task and used to execute the first target task.

The way of obtaining the first prompt images in this disclosure is described in detail below.

In some embodiments, the way of obtaining each first prompt image based on the image to be processed and the prompt information includes but is not limited to the following two manners.

The first manner: corresponding target pixel values are added to at least a part of the pixels of the image to be processed to obtain each first prompt image.

FIG. 4A shows a schematic diagram of adding target pixel values to each pixel of an image to be processed. It may be understood that multiple target pixel values may constitute the target pixel value image 402 in FIG. 4A, and the size of the target pixel value image 402 is the same as that of the image to be processed 401. The first prompt image 403 may be obtained by combining the image to be processed 401 with the target pixel value image 402.

Illustratively, if a resolution of the image to be processed is 2 k (for example, 2560×1440), it indicates that the image to be processed has 2560 pixels in a horizontal direction and 1440 pixels in a vertical direction. Therefore, the image to be processed includes 2560×1440 pixels in total.

If the image to be processed includes m×n pixels, and target pixel values are added to each pixel of the image to be processed, there may also be m×n added target pixel values. For example, for a first pixel in the j th row (j is an integer greater than 0 and less than or equal to m) and the i th column included in the image to be processed, a target pixel value in the j th row and the i th column of the target pixel values may be added to obtain a target pixel. Then, each target pixel value may be added one by one to each first pixel included in the image to be processed in the foregoing manner until all m×n pixels included in the image to be processed are updated. It can be understood that m×n target pixels may form a first prompt image.

The second manner: Add prompt marks to the image to be processed.

The form of the prompt mark is not limited in some embodiments of this disclosure. For example, the prompt mark may be the pixel with a pixel value. Understandably, when the first sub-model is a convolutional neural network model, convolution operations are often used to perform the first target task on the image to be processed. In the convolution operation of the image to be processed, the calculation times of the edge pixels of the image to be processed are less, which makes the analysis of the edge pixels of the image less, thus affecting the prediction result of the first target task performed on the image. Therefore, adding image areas around the image to be processed, such as adding pixel values, can contribute to the execution of the first target task.

As shown in FIG. 4B, multiple target pixel values may constitute a target pixel value image 404 (the shaded part) in FIG. 4B, and a corresponding target pixel value image 404 is added around the image to be processed 401, to obtain the first prompt image 405. Illustratively, the target pixel value image 404 may include pixel values of pixels, which is not limited in embodiments of this disclosure.

303: Input each first prompt image corresponding to each first target task into the first sub-model to obtain M prediction results of M first target tasks.

It may be understood that because the first sub-model includes one backbone and M heads, and one head corresponds to one first target task, so the process of obtain a prediction result of each first target task after inputting each first prompt image into the first sub-model to may be as follows: inputting each first prompt image into the backbone in the first sub-model, and the backbone performs feature extraction on each first prompt image to obtain a feature corresponding to each extracted first prompt image. Then, each head executes each first target task based on the corresponding feature of each first prompt image, and outputs a prediction result corresponding to each first target task.

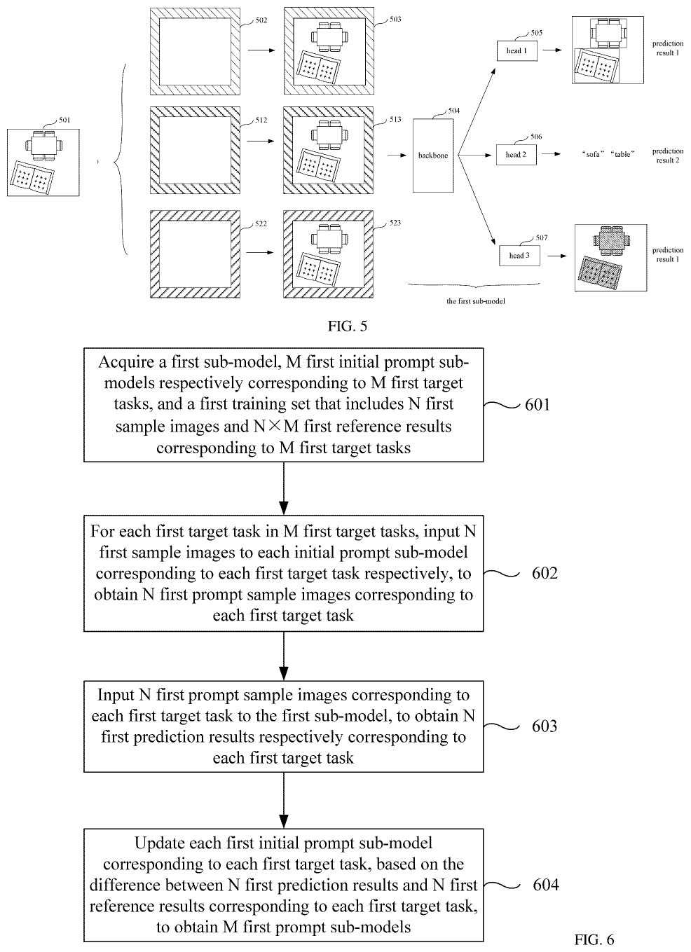

FIG. 5 shows a schematic flow diagram of executing image processing on an image to be processed including a sofa and a table according to this disclosure. In FIG. 5, the prompt information added around the image to be processed 501 is shown as an example. In this method, prompt information 502 may be added on the image to be processed 501 to obtain a first prompt image 503. Then, the first prompt image 503 is input to the backbone 504 in the first sub-model to perform feature extraction. And then the extracted feature is input to the head 1 (505) in the first sub-model to execute the corresponding first target task. In FIG. 5, the first target task corresponding to the head 1 is target detection, which means detecting the sofa and the table in the image to be processed 501. Therefore, as shown in FIG. 5, in the image corresponding to the prediction result 1 output by the head 1, the sofa and the table are separately identified by using border boxes.

Similarly, the first prompt image 513 may be obtained by adding prompt information 512 on the image to be processed 501. Then, the first prompt image 513 is input to the backbone 504 in the first sub-model for feature extraction, and then the extracted feature is input to the header 2 (506) in the first sub-model to execute the corresponding first target task. In FIG. 5, the first target task corresponding to the head 2 is image recognition, which means identifying the objects included in the image to be processed 501. Therefore, as shown in FIG. 5, the prediction result 2 output by the head 2 is “sofa” and “table”.

The first prompt image 523 may be obtained by adding the prompt information 522 on the image to be processed 501. Then, the first prompt image 523 is input to the backbone 504 in the first sub-model to perform feature extraction, and then the extracted feature is input to the head 3 (507) in the first sub-model to execute the corresponding first target task. In FIG. 5, the first target task corresponding to the head 3 is semantic segmentation, and the prediction result 3 is output by the head 3.

In some embodiments, parameters of the backbone and each head in the first sub-model may be pre-trained parameters. In this case, each first prompt sub-model corresponding to each first head may be trained in the following manner.

FIG. 6 shows a schematic flow diagram of training first prompt sub-models. As shown in FIG. 6, the training process includes the following steps:

601: Acquire a first sub-model, M first initial prompt sub-models respectively corresponding to M first target tasks, and a first training set that includes N first sample images and N×M first reference results corresponding to M first target tasks.

It may be understood that the first sub-model is the foregoing trained multi-task learning model, that is, the first sub-model has the capability of executing M first target tasks on an input image. The training method of the first sub-model can be referred to the foregoing description, so details are not described herein again.

In some embodiments, because one first target task corresponds to one prompt information, and one first initial prompt sub-model is used to add the prompt information to the first sample image, so one first target task corresponds to one initial prompt sub-model. In some embodiments, each first initial prompt sub-model may be trained to obtain a first target prompt sub-model corresponding to each first target task. Each first target prompt sub-model may add corresponding prompt information to an input image, so as to help the first sub-model execute the first target task respectively. It may be understood that parameters in the first initial prompt sub-model may be set randomly, which is not limited in this disclosure. The process of setting parameters in the first initial prompt sub-model may also be referred to as an initialization process of parameters in the first initial prompt sub-model. In addition, the training method of the first initial prompt sub-model will be described below, so details are not described herein.

The type of the N first sample images is not limited in embodiments. For example, the first sample image may be the landscape image, the figure image, the animal image, or the like. In addition, types of the N first sample images may be the same or different, which is not limited in the embodiments of this disclosure. The way in which the electronic device acquires the N first sample images may be that the electronic device receives the N first sample images uploaded by the user, or may be that the electronic device acquires the N first sample images from an image platform (for example, an image website).

In some embodiments, when one first target task is executed, one first sample image corresponds to one first reference result, and therefore, N first sample images corresponds to N first reference results. Then, in a case in which there are M first target tasks, N first sample images corresponds to N×M first reference results. The way of determining first reference results is not limited in embodiments of this disclosure. For example, first reference results may be obtained by means of manual labeling. What's more, the type of first reference results may be determined based on the type of first target tasks. For example, the type of first reference results may be images, texts, or the like.

602: For each first target task in M first target tasks, input N first sample images to each initial prompt sub-model corresponding to each first target task respectively, to obtain N first prompt sample images corresponding to each first target task.

It may be understood that principles of determining each first prompt sample image corresponding to each first target task are the same. Therefore, for ease of description, in the following, a first target task in the first target tasks is used as an example to describe the determining way of the N first prompt sample images corresponding to a first target task.

It may be understood that after the N first sample images are input into a first initial prompt sub-model corresponding to the first target task, N first prompt sample images corresponding to the first target task can be obtained. The process of obtaining the N first prompt sample images may be the process of adding the first initial prompt information corresponding to the first target task on the N first sample images. The manner of adding the prompt information on the first sample image is the same as that described in step 302 in the foregoing, so details are not described herein again.

603: Input N first prompt sample images corresponding to each first target task to the first sub-model, to obtain N first prediction results respectively corresponding to each first target task.

It may be understood that, when one first target task is executed, one first prompt sample image corresponds to one first prediction result, and N first prompt sample images are corresponding to N first prediction results.

604: Update each first initial prompt sub-model corresponding to each first target task, based on the difference between N first prediction results and N first reference results corresponding to each first target task, to obtain M first prompt sub-models.

Also take a first target task as an example, it may be understood that after N first prompt sample images corresponding to the first target task are input into the first sub-model, the N first prediction results corresponding to the first target task may be obtained. Then a total result loss is obtained based on the difference between N first prediction results and N first reference results corresponding to the first target task. The related parameters in the first initial prompt sub-model corresponding to the first target task then can be updated, based on the total result loss, to obtain the updated first initial prompt sub-model.

Determining whether the first initial prompt sub-model obtained after the training meets the training termination condition. If so, terminating training of the first initial prompt sub-model, and using the first initial prompt sub-model obtained after the training as the first target prompt sub-model corresponding to the first target task. If the first initial prompt sub-model obtained after the training does not meet the training termination condition, the sub-model obtained continues to be updated with reference to the manner of step 601 to step 604, until the training termination condition is met.

It can be understood that one first prediction result corresponds to one first reference result. Therefore, the manner of obtaining a total result loss based on the difference between the N first prediction results and the N first reference results corresponding to the first target task may be: obtaining a result loss based on the difference between one first prediction result and a corresponding first reference result. Then, the N result losses may be obtained based on the N first prediction results and the N first reference results, and then the N result losses can be summed to obtain the total result loss corresponding to N first prediction results and N first reference results.

In some embodiments, the manner of obtaining a result loss based on the difference between a first prediction result and a corresponding first reference result is not limited. For example, a cross entropy loss or a mean square error loss may be used as a result loss.

It may be understood that the training termination condition is set according to experience or flexibly adjusted according to an application scenario, which is not limited in embodiments of this disclosure. For example, the training termination condition includes but is not limited to any one of the following: the quantity of update times of parameters executed when the first initial prompt sub-model trained is obtained reaches a quantity threshold; the total result loss is less than a loss threshold; the total result loss converges.

For ease of description, in this step, only one first target task is used as an example to describe the training process of a first initial prompt sub-model corresponding to the first target task. However, it should be understood that the principle of training each first initial sub-model corresponding to each first target task is the same, so details are not described in embodiments.

For example, based on the foregoing description, the first training set may be represented as D₁={xᵢ, yᵢ¹, . . . , yᵢ^{M}}ᵢ₌₁^{N}. xᵢ represents the i th first sample image, and the value range of i is [1, N]. yᵢ^{j} represents a first reference result of the j th first target task corresponding to the i th first sample image, and the value range of j is [1, M]. In addition, the first sub-model may be represented by

$${f}_{\{ {θ}_{b} , {θ}_{{t}_{1} , ... ,} {θ}_{{t}_{M}} \}} ,$$

wherein θ_{b} indicates parameters of the backbone, and θₜ_{ⱼ}) indicates parameters of a head corresponding to the j th first target task.

The first initial prompt sub-model corresponding to the j th first target task of the i th first sample image is used as an example. It may be understood that, because the process of updating parameters of the first initial prompt sub-model corresponding to the j th first target task is the process of training the first initial prompt information corresponding to the j th first target task, the first prediction result of the j th first target task of the ith first sample image may be represented as

$${f}_{\{ {θ}_{b ,} {θ}_{{t}_{j}} \}} ( {x}_{i} , {p}_{j} ) , ,$$

the first initial prompt information corresponding to the j th first target task.

Then, a result loss

$${L}_{j} ( {f}_{\{ {θ}_{b ,} {θ}_{{t}_{j}} \}} ( {x}_{i} , {p}_{j} ) , {y}_{i}^{j} )$$

may be obtained based on the first prediction result and the first reference result of the j th first target task yᵢ^{j}. Each result loss of the j th first target task corresponding to each of N first sample images is summed to obtain a total result loss Lₜ_{ⱼ}. The calculation method of Lₜ_{ⱼ} can refer to the following formula (2):

$${L}_{{t}_{j}} = {\sum }_{i = 1}^{N} {L}_{j} ( {f}_{\{ {θ}_{b} , {θ}_{{t}_{j}} \}} ( {x}_{i} , {p}_{j} ) , {y}_{i}^{j} ) \qquad formula ( 2 )$$

After the total result loss Lₜ_{ⱼ} is obtained, the pⱼ in foregoing formula (2) may be updated to obtain updated total result loss Lₜ_{ⱼ} until the updated total result loss Lₜ_{ⱼ} meets the training termination condition. Take the training termination condition which is the total result loss converges as an example, the update target may be briefly expressed as follows:

$$arg {min}_{P} E ( L ( {F}_{\{ {θ}_{b} , {θ}_{t} \}} ( X , P ) , Y ) ) \qquad formula ( 3 )$$

In the foregoing formula (3), L(f_{(θ}_{_{b}}_{,θ}_{ₜ}₎(X, P), Y) is equivalent to the total result loss in the foregoing formula (2); argmin ( ) function represents the minimum value; E ( ) function indicates the expected value. The formula (3) represents that the expected value of the total result loss Lₜ_{ⱼ} is minimized by updating pⱼ. That is to say, if the total result loss Lₜ_{ⱼ} doesn't meet the training termination condition (convergence), pⱼ is updated based on the total result loss Lₜ_{ⱼ} according to 601-604, until E(Lₜ_{ⱼ}) meeting the training termination condition is obtained.

In the method provided in embodiments of this disclosure, prompt information is added to an image to be processed to obtain a first prompt image, and then a first target task corresponding to the prompt information is performed on the prompt image based on a first sub-model. In addition, the prompt information has a prompt function for execution of the first target task, and is strongly related to a result of the first target task. Therefore, the first sub-model may be assisted to execute each first target task, so as to output a corresponding prediction result.

In addition, both the backbone and each head in the first sub-model in the method are pre-trained. Compared with the manner of executing the first target task on the image to be processed only according to the trained first sub-model, the method provided in this disclosure further adds, before the image to be processed is input to the first sub-model, prompt information strongly related to the result of the first target task, which can further improve accuracy of prediction results of the first target tasks.

In other embodiments, parameters of each first prompt sub-model and each head in the first sub-model may also be trained in synchronization. For example, parameters of the backbone and each head in the first sub-model may be initialized first, and then parameters of each first prompt sub-model and each head are adjusted based on the training set, to obtain the updated first prompt sub-models and the updated first sub-model.

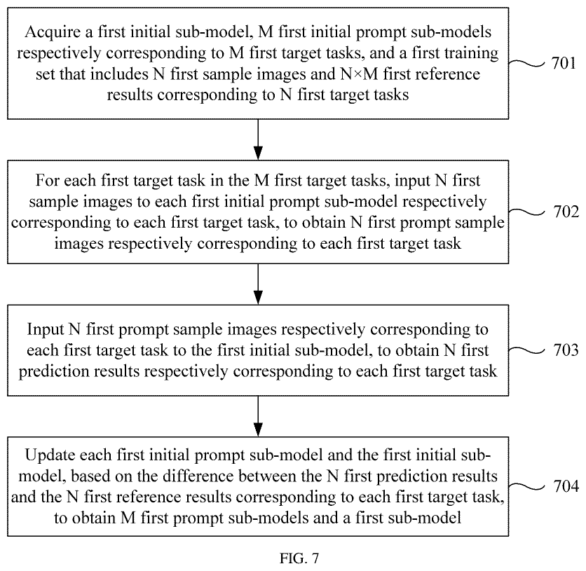

FIG. 7 shows a schematic flow diagram of training first prompt sub-models and the first sub-model. As shown in FIG. 7, the training process includes the following steps:

701: Acquire a first initial sub-model, M first initial prompt sub-models respectively corresponding to M first target tasks, and a first training set that includes N first sample images and N×M first reference results corresponding to N first target tasks.

It may be understood that the first initial sub-model may be the foregoing multi-task learning model after initialization of parameters of the backbone and each head. In embodiments, parameters of each head may be trained to obtain the first sub-model in the foregoing step 301. Therefore, it may be understood that the process of training the first initial sub-model to obtain the first sub-model is the process of training parameters of each head.

702: For each first target task in the M first target tasks, input N first sample images to each first initial prompt sub-model respectively corresponding to each first target task, to obtain N first prompt sample images respectively corresponding to each first target task.

703: Input N first prompt sample images respectively corresponding to each first target task to the first initial sub-model, to obtain N first prediction results respectively corresponding to each first target task.

It may be understood that the principle of the foregoing step 702-703 is the same as that of the foregoing step 602-603, so details are not described herein again.

704: Update each first initial prompt sub-model and the first initial sub-model, based on the difference between the N first prediction results and the N first reference results corresponding to each first target task, to obtain M first prompt sub-models and a first sub-model.

It may be understood that the process of obtaining the first sub-model by updating the first initial sub-model based on the difference between the N first prediction results and the N first reference results is: updating each first initial head to obtain each corresponding first head, so as to obtain the first sub-model.

It may be understood that a total result loss may be obtained based on the difference between the N first prediction results and the N first reference results corresponding to the first target task. Then, related parameters of the first initial prompt sub-model and the first initial head corresponding to the first target task can be updated based on the total result loss, to obtain an updated first initial prompt sub-model and an updated first initial head.

Determining whether the first initial prompt sub-model and the first initial head after the training meet the training termination condition. If so, terminating training of the first initial prompt sub-model and the first initial head, and using the first initial prompt sub-model after training as the first prompt sub-model corresponding to the first target task, and using the first initial head after training as the first head corresponding to the first target task.

If the first initial prompt sub-model and the first initial head obtained after the training do not meet the training termination condition, the sub-model and the head continue to be updated in the manner of step 701 to step 704, until the training termination condition is met.

In this case, the total result loss of the j th first target task respectively corresponding to the N first sample images, can also refer to the foregoing formula (2), so details are not described herein again. After the total result loss Lₜ_{ⱼ} is obtained, pⱼ and θtⱼ in the formula (2) may be updated to obtain updated total result loss Lₜ_{ⱼ} until the updated total result loss Lₜ_{ⱼ} meets the training termination condition. Take the training termination condition which is the total result loss converges as an example, the update target may be briefly expressed as follows:

$$arg {min}_{P , {θ}_{t}} E ( L ( {F}_{\{ {θ}_{b} , {θ}_{t} \}} ( X , P ) , Y ) ) \qquad formula ( 4 )$$

The formula (4) indicates that the expected value of the total result loss is minimized (i.e., converged) by updating pⱼ and θₜ_{ⱼ}. That is to say, if the total result loss Lₜ_{ⱼ} doesn't meet the training termination condition (convergence), pⱼ and θₜ_{ⱼ} are updated based on the total result loss Lₜ_{ⱼ} according to 701-704, until E(Lₜ_{ⱼ} meeting the training termination condition is obtained.

In the method provided in embodiments of this disclosure, prompt processing is performed on an input image, which means prompt information is added to an input image. Therefore, in the training process of the first sub-model, parameters of the backbone of the first sub-model may not be updated, and only parameters of the head and prompt information corresponding to each first target task may be trained. By doing so, the updated first sub-model may also have good performance in executing each first target task. In addition, parameters of the backbone is far more than parameters of a prompt sub-model that performs prompt processing on an input image. Therefore, compared with the manner in which parameters of both backbone and each head need to be trained to obtain the first sub-model, parameters of the backbone does not need to be trained in this method, which reduces the quantity of parameters that need to be updated, and the calculation amount is relatively low, thereby improving training efficiency.

It may be understood that, regardless of the training manner of the first sub-model and the first prompt sub-model, after the foregoing first sub-model and the first prompt sub-model corresponding to each first target task are trained to obtain the image processing model, if the capability of executing a new second target task by the model needs to be added, only the second prompt sub-model and the second head for the second target task may be trained.

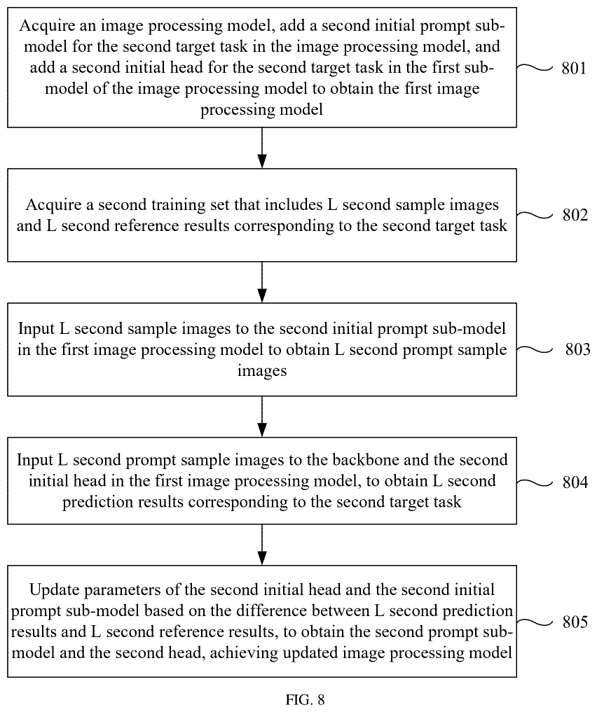

FIG. 8 shows a schematic flow diagram of training the image processing model when a second target task is added. As shown in FIG. 8, the training process includes the following steps:

801: Acquire an image processing model, add a second initial prompt sub-model for the second target task in the image processing model, and add a second initial head for the second target task in the first sub-model of the image processing model to obtain the first image processing model.

It may be understood that the image processing model includes M first prompt sub-models corresponding to M first target tasks and the first sub-model described in the foregoing content. That is to say, the image processing model has the capability of executing M first target tasks on an input image.

After the image processing model is acquired, a second initial head and a second initial prompt sub-model corresponding to the second target task may be added in the image processing model, wherein parameters of the second initial head and the second initial prompt sub-model may be initialized parameters. In the method provided in embodiments of this disclosure, the second initial head and the second initial prompt sub-model corresponding to the second target task may be trained to obtain a second head and the second prompt sub-model. The manner of obtaining the second head and the second prompt sub-model will be described in the following content, so details are not described herein.

In some embodiments, the type of the second target task is not limited, and the second target task may be different from M first target tasks that can be executed by the first sub-model. Because one target task corresponds to one prompt information, one second target task corresponds to one second initial prompt sub-model.

802: Acquire a second training set that includes L second sample images and L second reference results corresponding to the second target task.

The type of the second sample images is not limited in embodiments of this disclosure. For example, the second sample images may be landscape images, figure images, animal images, or the like. In addition, types of the L second sample images may be the same or different, which are not limited in this disclosure. The manner in which the electronic device acquires the L second sample images may be that the electronic device receives the second sample images uploaded by the user, or may be that the electronic device acquires the second sample images from an image platform (for example, a picture website), which is not limited in this embodiment. It may be understood that the content and the quantity of the second sample images may be the same as or different from those of the foregoing first sample images, which are also not limited.

In some embodiments, when the second target task is executed, one second sample image corresponds to one second reference result, and therefore, L second sample images correspond to L second reference results. Illustratively, the second reference results may be results obtained by means of manual labeling. The type of the second reference results may be determined based on the type of the second target task, and the type of the second reference results may be images, texts, or the like.

803: Input L second sample images to the second initial prompt sub-model in the first image processing model to obtain L second prompt sample images.

It may be understood that one second sample image corresponds to one second prompt sample image. So the process of inputting L second sample images into the second initial prompt sub-model to obtain L second prompt sample images may be the process of, adding second initial prompt information corresponding to the second target task to L second sample images. The second initial prompt information may be information set randomly. The manner of adding the second initial prompt information on the second sample images is the same as that described in step 302 in the foregoing description, so details are not described herein again.

804: Input L second prompt sample images to the backbone and the second initial head in the first image processing model, to obtain L second prediction results corresponding to the second target task.

It may be understood that one second prediction result can be obtained by executing one second target task on one second prompt sample image. Therefore, L second prediction results can be obtained by executing one second target task on L second prompt sample images.

805: Update parameters of the second initial head and the second initial prompt sub-model based on the difference between L second prediction results and L second reference results, to obtain the second prompt sub-model and the second head, achieving updated image processing model.

It may be understood that a total result loss may be obtained based on the difference between L second prediction results and L second reference results corresponding to the second target task. Then, related parameters of the second initial prompt sub-model and the second initial head corresponding to the second target task are updated based on the total result loss, to obtain an updated second initial prompt sub-model and updated second initial head.

Determining whether the second initial prompt sub-model and the second initial head obtained after the training meet the training termination condition. If so, terminating training of the second initial prompt sub-model and the second initial head, and using the second initial prompt sub-model obtained after the training as the second prompt sub-model corresponding to the second target task, using the second initial head obtained after the training as the second head corresponding to the second target task.

If the second initial prompt sub-model and the second initial head obtained after the training do not meet the training termination condition, the second initial prompt sub-model and the second initial head continue to be updated in the manner of step 801 to step 805, until the training termination condition is met

For example, based on the foregoing description, the second training set may be represented as DD₂={xᵢ, yᵢ^{M+1}}ᵢ₌₁^{N}. xᵢ represents the i th second sample image, and the value range of i is [1, L]. yᵢ^{M+1} represents the second reference result of the M+1 th first target task (the second target task) corresponding to the i th second sample image. In addition, the first sub-model after the second initial head is added may be represented as

$${f}_{\{ {θ}_{b} , {θ}_{{t}_{1} , ... ,} {θ}_{{t}_{M}} , {θ}_{{t}_{M + 1}} \}} ,$$

wherein θ_{b} indicates parameters of the backbone, and θₜ_{_{M+1}} indicates parameters of the head corresponding to the second target task.

When training the second initial prompt sub-model and the second initial head corresponding to the M+1 th first target task (the second target task), because the process of updating parameters of the second initial prompt sub-model corresponding to the second target task is a process of training the second initial prompt information corresponding to the second target task, the second prediction result of the second target task on the i th second sample image may be represented as

$${f}_{\{ {θ}_{b ,} {θ}_{{t}_{M + 1}} \}} ( {x}_{i} , {p}_{M + 1} ) ,$$

wherein p_{M+1} indicates the second initial prompt information corresponding to the second target task.

Then, a result loss

$${L}_{M + 1} ( {f}_{\{ {θ}_{b ,} {θ}_{{t}_{M + 1}} \}} ( {x}_{i} , {p}_{M + 1} ) , {y}_{i}^{M + 1} )$$

m may be obtained based on the second prediction result and the second reference result yᵢ^{M+1} of the second target task. Then, each result loss of the second target task on each second sample image in the N second sample images are summed to obtain a total result loss of the second target task. The calculation method of L_(t_(M+1)) can refer to the following formula (5):

$${L}_{{t}_{M + 1}} = {\sum }_{i = 1}^{N} {L}_{M + 1} ( {f}_{\{ {θ}_{b ,} {θ}_{{t}_{M + 1}} \}} ( {x}_{i} , {p}_{M + 1} ) , {y}_{i}^{M + 1} ) \qquad formula ( 5 )$$

After the total result loss Lₜ_{_{M+1}} is obtained, p_{M+1} and θₜ_{_{M+1}} in the foregoing formula (5) may be updated by using the total result loss Lₜ_{_{M+1}} until the updated total result loss Lₜ_{_{M+1}} obtained by the updated p_{M+1} and θₜ_{_{M+1}} meets the training termination condition. Take the training termination condition which is convergence of the total result loss as an example, the update target may be briefly expressed as the following formula (6):

$$arg {min}_{{P}_{M + 1} , {θ}_{{t}_{M + 1}}} E ( L ( {f}_{\{ {θ}_{b} , {θ}_{{t}_{M + 1}} \}} ( X , {P}_{M + 1} ) , {Y}^{M + 1} ) ) \qquad formula ( 6 )$$

In the foregoing formula (6),

$$L ( {f}_{\{ {θ}_{b} , {θ}_{{t}_{M + 1}} \}} ( X , {P}_{M + 1} ) , {Y}^{M + 1} )$$

is equivalent to the total result loss in the foregoing formula (5).

$$arg {min}_{{P}_{M + 1} , {θ}_{{t}_{M + 1}}} E ( L ( {f}_{\{ {θ}_{b} , {θ}_{{t}_{M + 1}} \}} ( X , {P}_{M + 1} ) , {Y}^{M + 1} ) )$$

indicates that the expected value of the total result loss Lₜ_{_{M+1}} is minimized (i.e., converged) by updating p_{M+1} and θₜ_{_{M+1}}. That is to say, if the total result loss Lₜ_{_{M+1}} doesn't meet the training termination condition (convergence), p_{M+1} and θₜ_{_{M+1}} are updated based on the total result loss Lₜ_{_{M+1}} according to 801-805, until E(Lₜ_{_{M+1}}) meeting the training termination condition is obtained.

The foregoing process is described by using an example in which related parameters of the second initial prompt sub-model and the second initial head are simultaneously trained. However, it may be understood that the training may also be successively performed on the second initial head and the second initial prompt sub-model. For example, the second initial head may be trained to obtain the second head corresponding to the second target task, and then the second initial prompt sub-model is trained based on the second head to obtain the second prompt sub-model.

In the method provided in this disclosure, when the capability of executing a new second target task needs to be added in the image processing model, only prompt information and parameters of a new head corresponding to the new second target task may be trained. Compared with the manner of training parameters of the backbone and each head (including parameters of the new head), the method provided in this disclosure may reduce the quantity of parameters that need to be updated, and the calculation amount is relatively low, thereby improving training efficiency.

For example, taking the image processing model shown in FIG. 3A above as an example, if the capability of executing the second target task (i.e. M+1 th first target task) needs to be added in the image processing model, only the second head (the M+1 th first head) and the M+1 th first prompt sub-model will be added. And then the relevant parameters in the M+1 th first head and the M+1 first prompt sub-model are trained, to make the updated image processing model capable of performing the M+1 th first target task.

The above just describes the training process of the image processing model when adding the ability to perform the second target task by taking the second initial prompt sub-model and the second initial head as examples. But it should understood that in this case, the parameters of the image processing model, the second initial prompt sub-model and the second initial head can also be updated. By doing so, the accuracy of performing each target task by the updated image processing model can be improved.

The following table 1 shows the accuracy of completing each first target task in different update manners of the first sub-model.

TABLE 1

| | TaskID | | | | | | | | | | |
|---|---|---|---|---|---|---|---|---|---|---|---|
| | | | | | | | | | | Ave | |
| | 0 | 1 | 2 | 3 | 4 | 5 | 6 | 7 | 8 | ACC | Improv |
| Pretrained | 0.882 | 0.824 | 0.906 | 0.774 | 0.926 | 0.948 | 0.829 | 0.93 | 0.961 | 0.887 | |
| Pretrained + | 0.882 | 0.824 | 0.906 | 0.774 | 0.926 | 0.949 | 0.830 | 0.930 | 0.961 | 0.887 | 0 |
| Taskheads | | | | | | | | | | | |
| End2End | 0.913 | 0.890 | 0.942 | 0.837 | 0.952 | 0.955 | 0.921 | 0.941 | 0.981 | 0.926 | 0.039 |
| Sum | 0.90 | 0.873 | 0.939 | 0.818 | 0.945 | 0.952 | 0.916 | 0.942 | 0.981 | 0.919 | 0.032 |
| Prompt | | | | | | | | | | | |
| (Initlr = 0.001) | | | | | | | | | | | |
| Sum | 0.912 | 0.884 | 0.943 | 0.828 | 0.951 | 0.954 | 0.922 | 0.947 | 0.983 | 0.925 | 0.038 |
| Prompt | | | | | | | | | | | |
| (Initlr = 0.01) | | | | | | | | | | | |
| Padding | 0.889 | 0.86 | 0.929 | 0.800 | 0.935 | 0.949 | 0.868 | 0.935 | 0.979 | 0.905 | 0.018 |
| Prompt | | | | | | | | | | | |
| (Initlr = 0.001) | | | | | | | | | | | |
| Padding | 0.892 | 0.872 | 0.937 | 0.812 | 0.939 | 0.951 | 0.884 | 0.936 | 0.98 | 0.911 | 0.024 |
| Prompt | | | | | | | | | | | |
| (Initlr = 0.01) | | | | | | | | | | | |

As shown in Table 1, TaskID represents an identity document of a first target task. In some embodiments, there are nine TaskIDs from 0 to 8, and each TaskID corresponds to different first target task. In addition, Ave ACC in Table 1 represents an average accuracy value of nine first target tasks of each training manner. Improv indicates the improvement value of the average accuracy value of each training manner compared with that of the manner of Pre-trained+task heads. That is to say, Pre-trained+task heads is a control group.

In Table 1, Pre-trained indicates that, in an update process of the first model, parameters of each head and the backbone are updated for each first target task. The value of the row in which the Pre-trained is located indicates the accuracy of performing different first target tasks by using the first sub-model obtained by means of training in this manner. The training manner represented by Pre-trained+task heads is that parameters of the backbone with relatively high accuracy in the Pre-trained manner are used, and then parameters of each head are adjusted based on parameters of the backbone, so that an updated first sub-model can execute each first target task. It may be learned from Table 1 that accuracy of executing each first target task in the Pre-trained manner and the Pre-trained+task heads manner is similar.

End2End indicates that in a case in which parameters of the backbone and each head in the first sub-model are randomly initialized, parameters of the backbone and each head are updated in the training process of the first sub-model. Sum prompt indicates that prompt information is added on the sample image to change pixel values of pixels in the sample image, and then parameters of each head are trained when parameters of the backbone and each head are randomly initialized. What's more, Init lr=0.001 and init lr=0.01 in Table 1 indicate different hyperparameters selected in the training process.

Padding prompt indicates that prompt information is added around the sample image, for example, pixels are added around the sample image, and then parameters of each head are trained when parameters of the backbone and each head are randomly initialized.

It may be learned from Table 1 that the average accuracy value of the Sum prompt manner is greater than that of the Padding prompt manner. In addition, compared with the average accuracy value of the Pre-trained+task heads manner, the average accuracy value of the End2End manner increases by 0.039, and the Sum prompt manner by 0.038. This indicates that the accuracy of only training the prompt information and parameters of the heads corresponding to each first target task is similar to that of training parameters of the backbone and each head. Therefore, in a case in which accuracy of the two manners is similar, the calculation amount in the training process of the Sum prompt manner is relatively small, so its training process is simpler, and efficiency is higher.

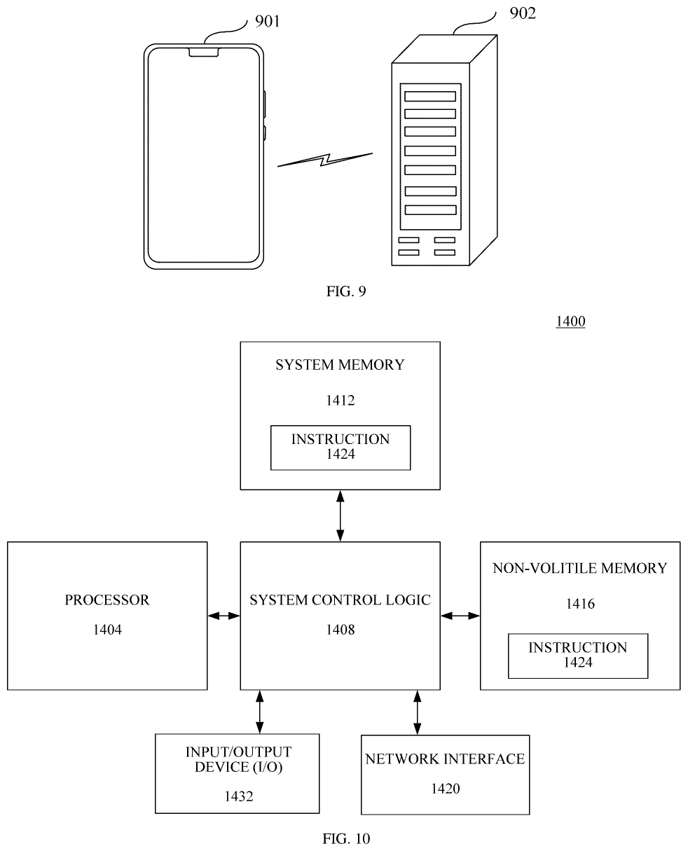

In addition, as shown in FIG. 9, the electronic device in this disclosure may further includes a first electronic device 901 and a second electronic device 902. The first electronic device 901 may be a client electronic device such as a mobile phone or a tablet computer, and the second electronic device 902 may be a cloud server or the like. In this case, for example, the first electronic device 901 may be configured to execute each target task on an input image. The second electronic device 902 may be configured to execute each training process involved in the embodiments of this disclosure, for example, the training process shown in FIG. 6 to FIG. 8.

It may be understood that, after completing training on parameters of related models, the second electronic device 902 may send these parameters to the first electronic device 901, and then the first electronic device 901 may execute each target task on the input image based on the received parameters.

For example, taking the image processing model shown in FIG. 3D above as an example, the second electronic device 902 can train parameters in the image processing model, and the trained parameters are then sent to the first electronic device 901, which then performs each first target task based on the updated parameters of the image processing model.

On this basis, if the capability of performing a new second target task (i.e. the M+1 th first target task) for the image processing model needs to be added, in the method provided in this disclosure, the second electronic device 902 can only add a second head (i.e., the M+1 th first head) and the M+1 th first prompt sub-model based on the previously trained image processing model. And then the relevant parameters in the M+1 th first head and the M+1 th first prompt sub-model are trained, to make the updated image processing model capable of performing the M+1 th first target task. The second electronic device 902 can then send the relevant parameters of the updated M+1 th first head and the M+1 th first prompt sub-model to the first electronic device 901.

Therefore, compared with the manner in which the second electronic device 902 needs to train parameters of the backbone and each head (including the head corresponding to the second target task), and send parameters of the backbone and each head after training to the first electronic device 901, in the method provided in this disclosure, the second electronic device 902 sends fewer parameters to the first electronic device 901, reduces the data amount in the parameter deployment process, and reduces deployment pressure.

FIG. 10 shows a schematic structural diagram of an apparatus 1400 according to an embodiment of the present disclosure. In one embodiment, the apparatus 1400 may include one or more processors 1404, system control logic 1408 coupled to at least one of the processors 1404, system memory 1412 coupled to the system control logic 1408, non-volatile memory (NVM) 1416 coupled to the system control logic 1408, and a network interface 1420 coupled to the system control logic 1408.

In some embodiments, the processors 1404 may include one or more single-core or multi-core processors. In some embodiments, the processors 1404 may include any combination of general-purpose processors and special purpose processors (e.g., graphics processors, disclosure processors, baseband processors, etc.). In embodiments where the apparatus 1400 employs an eNB (Evolved Node B) or a RAN (Radio Access Network) controller, the processors 1404 may be configured to perform various compliant embodiments, such as one or more of the various embodiments shown in FIG. 3A to FIG. 8.

In some embodiments, the system control logic 1408 may include any suitable interface controller to provide any suitable interface to at least one suitable device or component of the processors 1404 that may communicate with the system control logic 1408.

In some embodiments, the system control logic 1408 may include one or more memory controllers to provide interfaces to the system memory 1412. The system memory 1412 may be used to load and store data and/or instructions. The memory 1412 of the apparatus 1400 may include any suitable volatile memory, such as a suitable dynamic random-access memory (DRAM), in some embodiments.

The NVM/memory 1416 may include one or more tangible, non-transitory computer-readable media for storing data and/or instructions. In some embodiments, the NVM/memory 1416 may include any suitable non-volatile memory, such as flash memory, and/or any suitable non-volatile storage device, such as at least one of an HDD (Hard Disk Drive), a CD (Compact Disc) drive, and a DVD (Digital Versatile Disc) drive.

The NVM/memory 1416 may include a portion of storage resources on the device on which the apparatus 1400 is installed, or it may be accessed by, but not necessarily part of, the device. For example, the NVM/storage 1416 may be accessed over the network via the network interface 1420.

In particular, the system memory 1412 and NVM/memory 1416 may include a temporary copy and a permanent copy of instruction 1424, respectively. The instructions 1424 may include instructions that, when executed by at least one of the processors 1404, cause the apparatus 1400 to implement the methods shown in FIG. 3A to FIG. 8. In some embodiments, instructions 1424, hardware, firmware, and/or software components thereof may additionally/alternatively be placed in system control logic 1408, network interface 1420, and/or processors 1404.

The network interface 1420 may include a transceiver for providing a radio interface for the apparatus 1400 to communicate with any other suitable device (e.g., front-end module, antenna, etc.) via one or more networks. In some embodiments, the network interface 1420 may be integrated with other components of the apparatus 1400. For example, the network interface 1420 may be integrated with at least one of the followings: a system memory 1412, a NVM/memory 1416, and a firmware device (not shown). When the instructions are executed by at least one of the processors 1404, the apparatus 1400 can realize the methods shown in FIG. 3A to FIG. 8.

The network interface 1420 may further include any suitable hardware and/or firmware to provide a multiple-input multiple-output radio interface. For example, the network interface 1420 may be a network adapter, a wireless network adapter, a telephone modem, and/or a wireless modem.

In one embodiment, at least one of the processors 1404 may be packaged together with logic for one or more controllers of the system control logic 1408 to form a system SiP. In one embodiment, at least one of the processors 1404 may be integrated on the same die with logic for one or more controllers of the system control logic 1408 to form a system-on-chip (SoC).

The apparatus 1400 may further include an input/output (I/O) device 1432. The I/O device 1432 may include a user interface to enable a user to interact with the apparatus 1400. The peripheral component interface is designed so that the peripheral component can also interact with the apparatus 1400. In some embodiments, the apparatus 1400 further includes a sensor for determining at least one of environmental conditions and location information associated with the apparatus 1400.

In some embodiments, the user interface may include, but is not limited to, a display (e.g., a liquid crystal display, a touch screen display, etc.), a speaker, a microphone, one or more cameras (e.g., still image cameras and/or cameras), a flashlight (e.g., a light emitting diode flash), and a keyboard.

In some embodiments, peripheral component interfaces may include, but are not limited to, non-volatile memory ports, audio jacks, and power interfaces.

In some embodiments, the sensors may include, but are not limited to, gyroscope sensors, accelerometers, proximity sensors, ambient light sensors, and positioning units. The positioning unit may also be part of or interact with the network interface 1420 to communicate with components of the positioning network (e.g., a Global Positioning System (GPS) satellite).

As used herein, the term “module” may refer to or include, an application specific integrated circuit (ASIC), an electronic circuit, a processor (shared, dedicated, or group) and/or memory that executes one or more software or firmware programs, a combinational logic circuit, and/or other suitable hardware components that provides the described functionality. What's more, the term “module” may also be part of these hardware components.

It will be appreciated that in various embodiments of the present disclosure, the processor may be a microprocessor, a digital signal processor, a microcontroller, or the like, and/or any combination thereof. According to another aspect, the processor may be a single-core processor, a multi-core processor, or the like, and/or any combination thereof.

The embodiments disclosed herein may be implemented in hardware, software, firmware, or a combination of these implementations. Embodiments of the present disclosure may be implemented as a computer program or program code executing on a programmable system including at least one processor, a storage system (including volatile and non-volatile memory and/or storage elements), at least one input device, and at least one output device.

Program code may be applied to the input instructions to perform the functions described herein and to generate output information. The output information may be applied to one or more output devices in a known manner. For purposes of this disclosure, a processing system includes any system with a processor such as, a digital signal processor (DSP), a microcontroller, an application specific integrated circuit (ASIC), or a microprocessor.

The program code may be implemented in a high-level programming language or an object-oriented programming language to communicate with the processing system. The program code may also be implemented in assembly language or machine language, if desired. Indeed, the mechanisms described herein are not limited in scope to any particular programming language. In either case, the language may be a compilation language or an interpretation language.

In some cases, the disclosed embodiments may be implemented in hardware, firmware, software, or any combination thereof. The disclosed embodiments may also be implemented as instructions carried by or stored on one or more temporary or non-temporary machine-readable (e.g., computer-readable) storage media, which may be read and executed by one or more processors. For example, the instructions may be distributed through a network or through other computer-readable media. Thus, a machine-readable medium may include any mechanism for storing or transmitting information in a form readable by a machine (e.g., a computer), including, but not limited to, a floppy disk, an optical disk, an optical disk, a read-only memory (CD-ROMs), a magneto-optical disk, a read-only memory (ROM), a random access memory (RAM), an erasable programmable read-only memory (EPROM), an electrically erasable programmable read-only memory (EEPROM), a magnetic or optical card, a flash memory, or a tangible machine-readable memory for transmitting information (e.g., a carrier wave, an infrared signal, a digital signal, etc.) in an electrical, optical, acoustic, or other form of propagated signal using the Internet. Thus, a machine-readable medium includes any type of machine-readable medium suitable for storing or transmitting electronic instructions or information in a form readable by a machine (e.g., a computer).

In the drawings, some structural or methodological features may be shown in a particular arrangement and/or sequence. However, it should be understood that such a particular arrangement and/or ordering may not be required. Rather, in some embodiments, these features may be arranged in a manner and/or sequence different from that shown in the illustrative drawings. In addition, the inclusion of structural or methodical features in a particular figure is not meant to imply that such features are required in all embodiments. And in some embodiments, such features may not be included or may be combined with other features.

It should be noted that each unit/module mentioned in each device embodiment of the present disclosure is a logical unit/module. Physically, a logical unit/module may be a physical unit/module, may be a part of a physical unit/module, or may be implemented in a combination of a plurality of physical units/modules. The physical implementation of these logical units/modules is not the most important. The combination of functions implemented by these logical units/modules is the key to solving the technical problem proposed in the present disclosure. Furthermore, in order to highlight the inventive part of the present disclosure, the above-mentioned device embodiments of the present disclosure do not introduce units/modules which are not closely related to solving the technical problems set forth in the present disclosure, which does not indicate that the above-mentioned device embodiments do not have other units/modules.

It is to be noted that in the examples and description of this disclosure, relational terms such as first and second etc. are used solely to distinguish one entity or operation from another entity or operation, and do not necessarily require or imply any such actual relationship or order between such entities or operations. Moreover, the terms “comprises”, “comprising” or any other variation thereof, are intended to cover a non-exclusive inclusion, such that a process, method, article, or apparatus that comprises a list of elements includes not only those elements but also other elements not expressly listed, or also includes elements inherent to such process, method, article, or apparatus. Without further limitation, an element defined by the statement “comprises one” does not rule out there are additional identical elements in the process, method, article, or apparatus that includes the element.

While the present disclosure has been illustrated and described with reference to certain preferred embodiments thereof, it should be understood by those of ordinary skill in the art that various changes may be made in form and detail without departing from the scope of the present disclosure.

What is claimed is:

1. An image processing model training apparatus, the image processing model which is a convolutional neural network model including Y prompt modules and M image processing modules, each of the M image processing modules corresponding to at least one of the Y prompt modules, the apparatus comprising:
a memory for storing instructions; and
one or more processors for executing the instructions to cause the apparatus to:
acquire sample data including N sample images and a reference result corresponding to each of the N sample images;
add corresponding prompt information to the N sample images based on the Y prompt modules, to obtain N prompt sample images corresponding to each image processing module, wherein the prompt information is related to each image processing task of each image processing module;
predict the N prompt sample images corresponding to each image processing module, to obtain N prediction results corresponding to each image processing module; and
adjust parameters of the M image processing modules and the Y prompt modules based on the N prediction results and N reference results corresponding to each image processing module.

2. The apparatus of claim 1, wherein add corresponding prompt information to the N sample images based on the Y prompt modules comprises one of:
changing pixel values of at least a portion of pixels in the N sample images; or,
adding image areas around the N sample images to expand the N sample images.

3. The apparatus of claim 2, wherein an image processing task corresponding to an image processing module is image recognition; and
prompt information corresponding to the image processing task is added to the N sample images by changing pixel values of outline of each object to be recognized in the N sample images.

4. The apparatus of claim 2, wherein an image processing task corresponding to an image processing module is semantic segmentation; and
prompt information corresponding to the image processing task is added to the N sample images by changing pixel values of at least a portion of pixels of each object to be segmented in the N sample images.

5. The apparatus of claim 2, wherein an image processing task corresponding to an image processing module is depth estimation; and
prompt information corresponding to the image processing task is added to the N sample images by changing pixel values of pixels of each object to be estimated in the N sample images to increase color comparisons between objects to be estimated.

6. The apparatus of claim 1, wherein the image processing model further comprises a feature extraction module which is configured to:
perform feature extraction on the N prompt sample images output by each prompt module, and input extracted feature into the M image processing modules corresponding to the Y prompt modules.

7. An image processing model training method, the image processing model which is a convolutional neural network model including Y prompt modules and M image processing modules, each of the M image processing modules corresponding to at least one of the Y prompt modules, the method comprising:
acquiring sample data including N sample images and a reference result corresponding to each of the N sample images;
adding corresponding prompt information to the N sample images based on the Y prompt modules, to obtain N prompt sample images corresponding to each image processing module, wherein the prompt information is related to each image processing task of each image processing module;
predicting the N prompt sample images corresponding to each image processing module, to obtain N prediction results corresponding to each image processing module; and
adjusting parameters of the M image processing modules and the Y prompt modules based on the N prediction results and N reference results corresponding to each image processing module.

8. The method of claim 7, wherein adding corresponding prompt information to the N sample images based on the Y prompt modules comprises one of:
changing pixel values of at least a portion of pixels in the N sample images; or,
adding image areas around the N sample images to expand the N sample images.

9. The method of claim 8, wherein an image processing task corresponding to an image processing module is image recognition; and
prompt information corresponding to the image processing task is added to the N sample images by changing pixel values of outline of each object to be recognized in the N sample images.

10. The method of claim 8, wherein an image processing task corresponding to an image processing module is semantic segmentation; and
prompt information corresponding to the image processing task is added to the N sample images by changing pixel values of at least a portion of pixels of each object to be segmented in the N sample images.

11. The method of claim 8, wherein an image processing task corresponding to an image processing module is depth estimation; and
prompt information corresponding to the image processing task is added to the N sample images by changing pixel values of pixels of each object to be estimated in the N sample images to increase color comparisons between objects to be estimated.

12. The method of claim 7, further comprising:
performing feature extraction on the N prompt sample images output by each prompt module, and input extracted feature into the M image processing modules corresponding to the Y prompt modules.

13. A machine-readable storage medium storing instructions, which when executed by one or more processors, cause the machine to:
acquire sample data including N sample images corresponding to M image processing modules and a reference result corresponding to each of the N sample images, and the M image processing modules and Y prompt modules constitute an image processing model which is a convolutional neural network model, wherein each of the M image processing modules corresponds to at least one of the Y prompt modules;
add corresponding prompt information to the N sample images based on the Y prompt modules, to obtain N prompt sample images corresponding to each image processing module, wherein the prompt information is related to each image processing task of each image processing module;
predict the N prompt sample images corresponding to each image processing module, to obtain N prediction results corresponding to each image processing module;
adjust parameters of the M image processing modules and the Y prompt modules based on the N prediction results and N reference results corresponding to each image processing module.

14. The machine-readable storage medium of claim 13, wherein add corresponding prompt information to the N sample images based on the Y prompt modules comprises one of:
changing pixel values of at least a portion of pixels in the N sample images; or,
adding image areas around the N sample images to expand the N sample images.

15. The machine-readable storage medium of claim 14, wherein an image processing task corresponding to an image processing module is image recognition; and
prompt information corresponding to the image processing task is added to the N sample images by changing pixel values of outline of each object to be recognized in the sample images.

16. The machine-readable storage medium of claim 14, wherein an image processing task corresponding to an image processing module is semantic segmentation; and
prompt information corresponding to the image processing task is added to the N sample images by changing pixel values of at least a portion of pixels of each object to be segmented in the N sample images.

17. The machine-readable storage medium of claim 14, wherein an image processing task corresponding to an image processing module is depth estimation; and
prompt information corresponding to the image processing task is added to the N sample images by changing pixel values of pixels of each object to be estimated in the N sample images to increase color comparisons between objects to be estimated.

18. The machine-readable storage medium of claim 13, wherein the image processing model further comprises a feature extraction module which is configured to:
perform feature extraction on the N prompt sample images output by each prompt modules, and input extracted feature into the M image processing modules corresponding to the Y prompt modules.
